(19) United States
(12) Patent Application Publication
(10) Pub. No.: US 2026/0118204 A1
(43) Pub. Date: Apr. 30, 2026

(54) System for Inspecting Leaks Using Radiotracers

(71) Applicants: PETRÓLEO BRASILEIRO S.A. - PETROBRAS, Rio de Janeiro (BR); ATOMUM SERVIÇOS TECNOLOGICOS LTDA, Rio de Janeiro (BR); COMISSÃO NACIONAL DE ENERGIA NUCLEAR – IEN, Rio de Janeiro (BR)

(72) Inventors: Silvio Juer, Rio de Janeiro (BR); Carlos Eduardo Aguiar Lima Rodrigues, Santos (BR); Flavio Augusto Dos Santos Serra, Santos (BR); Julio Cesar Dualibi Filho, Rio de Janeiro (BR); Luis Eduardo Barreira Brandao, Rio de Janeiro (BR); Valeska Peres de Araujo, Rio de Janeiro (BR)

(73) Assignees: PETRÓLEO BRASILEIRO S.A. - PETROBRAS, Rio de Janeiro, RJ (BR); ATOMUM SERVIÇOS TECNOLOGICOS LTDA, Rio de Janeiro, RJ (BR); COMISSÃO NACIONAL DE ENERGIA NUCLEAR – IEN, Rio de Janeiro, RJ (BR)

(21) Appl. No.: 19/032,675

(22) Filed: Jan. 21, 2025

(30) Foreign Application Priority Data
Jan. 24, 2024 (BR) 1020240014952

(51) Int. Cl. G01M 3/22

(52) U.S. Cl. CPC G01M 3/22

(57) ABSTRACT

A radiotracer injection system for safe use in industrial plants allows for rapid coupling of the radiotracer element storage bottle. The entire set is fully pneumatically driven and allows radiotracer injection in the form of a rapid pulse or step pulse. The injector system can be used with radiotracers in liquid (aqueous or oil) and gaseous form. The system is a sealed and safe unit to work in systems with internal pressure up to 300 Bar. This prevents the need to handle radioactive material in industrial plants, as the radiotracer used in each injection is already delivered inside its respective bottle. Quick-coupling connections allow quick and safe exchange of a used bottle for one with a new radiotracer, without having to disconnect the injector from the system. The injection machine has cylindrical symmetry, which allows the use of shielding with prismatic lead bricks, forming a protective castle around the unit.

### CROSS-REFERENCE TO RELATED APPLICATIONS

This application claims priority to Brazilian Application No. BR1020240014952 filed on Jan. 24, 2024, the disclosure of which is expressly incorporated herein by reference in its entirety.

### FIELD OF THE INVENTION

The present invention relates to the development of an injector system to be used in inspections of printed circuit heat exchangers (PCHE) using radiotracer to identify leaks.

### BACKGROUND OF THE INVENTION

Online leak detection in industrial systems is one of the most commonly used applications of radiotracer techniques and the great advantage of this technique is the possibility of carrying out interventions in real time without influencing the normal operation of the installation. This feature demonstrates the great potential of using this methodology in identifying and locating leaks in heat exchangers of oil and natural gas field plants, especially in the offshore environment.

Among the techniques that use nuclear radiation, the radiotracers stand out for being extremely sensitive and requiring injections of very small quantities of the radioactive isotope so as not to alter the chemical composition of the fluids that run through the heat exchanger. By injecting the appropriate radiotracer to the conditions of the environment under study, the heat exchanger can be inspected and a possible leak identified without having to change the operating routine of the entire installation.

Furthermore, the high detection sensitivity of the employed systems allows the use of radiotracer low concentrations so as to not present a radiological risk to the health of workers and not cause damage or radiological/chemical contamination to the equipment and the environment. The International Atomic Energy Agency confirms this data in publications. Comparing the sensitivity of different technologies in identifying leaks in heat exchangers, radiotracers present the greatest sensitivity for “online” analysis.

Despite being a known technology, there is a major challenge related to its application in equipment operating at high pressure (up to 200 bar), such as the case with heat exchangers in the natural gas cooling system on platforms. The lack of knowledge of the appropriate methodology for the synthesis of the suitable gaseous radiotracer for the environment under study, as well as the system for its injection into the equipment to be evaluated, are critical factors for the success of the inspection and, therefore, must be studied and evaluated from the perspective of research and development.

Recent history on FPSO type platforms (Floating Production Storage and Offloading) indicate that leaks between flows in PCHE type exchangers cause the unscheduled shutdown of a platform for approximately 30 days, generating losses in oil production. The long shutdown is associated with the difficulty of identifying in which heat exchanger the leak occurred, as they are installed in line, forming a “train of exchangers”, requiring the disassembly of each of the heat exchangers to identify which one failed for subsequent repair, cleaning and reassembly.

The document “Leak Detection in Heat Exchangers and Underground Pipelines Using Radiotracers” discloses devices and methods for detecting leaks in heat exchangers and underground pipelines using radiotracers. Chapter 1 deals with leak detection in heat exchangers using radiotracers. More precisely, item 1.3. deals with detection methods, item 1.4.3. teaches the injection of the radiotracer element, and item 1.4.4. illustrates some examples of injection devices.

This document refers to only two models of industrial injectors. The first one mentioned on page 13, item “1.4.4-Radiation Detectors”, presents the scheme (FIG. 14) of an industrial injector for Ar-41 that uses a quartz capsule containing a radiotracer that, to be injected into the unit, has to be broken. The system is pressurized using a human-driven mechanical pump, which greatly limits the injection pressure range. Furthermore, as the quartz capsule is broken to release the radiotracer, pieces of this quartz are thrown into the high pressure phase and can cause clogging in the case of printed circuit exchangers on offshore platforms. The same page also shows the scheme of an injector developed for industrial radiotracers, but only for liquid phase injections (FIG. 15) and which only allows wide pulse injection.

A second model of injectors is also presented, specifically, heat exchangers (page 45, FIG. 62, item 2.2) and is a work by the Polish radiotracer group that presents a production and injection unit for the gaseous radiotracer CH3Br. In this unit, the synthesis of the radiotracer is carried out in the industrial plant itself and the injection system is a collection vessel for the radiotracer produced that is coupled to the reaction vessel. Each set—required by radioprotection standards—has a large lead shield weighing around 900 kg. In addition to the fact that it is practically impossible to move this entire structure across an offshore platform, the entire set would require a very large isolation area for safe operation.

Several examples of the use of radiotracer methodology in identifying leaks in industrial systems are also cited, but in all of them, there is no reference to the injection device used.

Therefore, the state of the art lacks an injection device or system that is easy to use and handle, with low risk for operators and that does not present a risk of damage to the plant.

### SUMMARY OF THE INVENTION

The present invention consists of a radiotracer injection system for detecting leak points. According to the present invention, the injection system consists of three modules that can be assembled separately, in which the module containing the bottle carrying the radiotracer can be completely sealed by means of one-way valves, allowing the transport of only the bottle module to various injection points, which facilitates the operation, in addition to making it faster and cheaper.

### BRIEF DESCRIPTION OF THE DRAWINGS

The present invention will now be described below with reference to the typical embodiments thereof and also with reference to the attached drawings, in which:

FIG. 1 is a representation of the first module of the radiotracer injection system according to the present invention;

FIG. 2 is a representation of the second module of the radiotracer injection system according to the present invention;

FIG. 3 is a representation of the third module of the radiotracer injection system according to the present invention;

FIG. 4 is a representation of a controlled leak simulation plant containing the injector system according to the present invention;

FIG. 5 is a graph representing the signals recorded by detector D1 during a first radiotracer injection test in the leak simulation plant;

FIG. 6 is a graph representing the signals recorded by the detector D7 from a first radiotracer injection test in the leak simulation plant;

FIG. 7 is a graph representing the radiotracer count of the first injection trial detected by detectors D1, D3, and D7;

FIG. 8 is a graph representing the radiotracer count of the first pulse of the first injection trial detected by detectors D1, D3, and D7;

FIG. 9 is a graph representing the radiotracer count of the first pulse of the first injection test detected by detectors D2, D4 and D8;

FIG. 10 is a detailed graph of the detectors D1 and D2 curves for the first pulse of the first injection test;

FIG. 11 is a graph representing the radiotracer count of the second pulse of the first injection test detected by detectors D1, D3, and D7;

FIG. 12 is a graph representing the radiotracer count of the second pulse of the first injection test detected by detectors D2, D4, and D8;

FIG. 13 is a graph representing the radiotracer count of the third pulse of the first injection test detected by detectors D1, D3, and D7;

FIG. 14 is a graph representing the radiotracer count of the third pulse of the first injection test detected by detectors D2, D4, and D8;

FIG. 15 is a graph representing the radiotracer counts of the third injection trial detected by detectors D1, D3, and D7;

FIG. 16 is a graph representing the CPS of the third injection test detected by detectors D1, D3 and D7 after treatment;

FIG. 17 is a graph representing the radiotracer element count of the third injection test detected by detectors D2, D4, and D8;

FIG. 18 is a graph representing the CPS of the third injection test detected by detectors D2, D4 and D8 after treatment;

FIG. 19 is a graph representing the CPS of the fourth injection test detected by detectors D1, D3 and D7;

FIG. 20 is a graph representing the CPS of the fourth injection test detected by detectors D2, D4 and D8;

FIG. 21 is a graph comparing the CPS curve with the treated CPS curve of detector D1;

FIG. 22 is a graph comparing the CPS curve with the treated CPS curve of the detector D3;

FIG. 23 is a graph comparing the CPS curve with the treated CPS curve of the detector D7.

### DETAILED DESCRIPTION OF THE INVENTION

Specific embodiments of this disclosure are described below. In an effort to provide a concise description of these embodiments, all features of an actual implementation may not be described in the specification. It should be appreciated that in the development of any actual implementation, as in any engineering project or design, numerous implementation-specific decisions must be made to achieve developers'specific goals, such as compliance with system- and business-related constraints, which can vary from one implementation to another. Furthermore, it should be appreciated that such a development effort may be complex and time-consuming, but would nevertheless be a routine design and manufacturing undertaking for those of ordinary skill having the benefit of this disclosure.

The injection system has three modules, which will be described separately below. All components must be suitable for operation at pressures up to 300 bar.

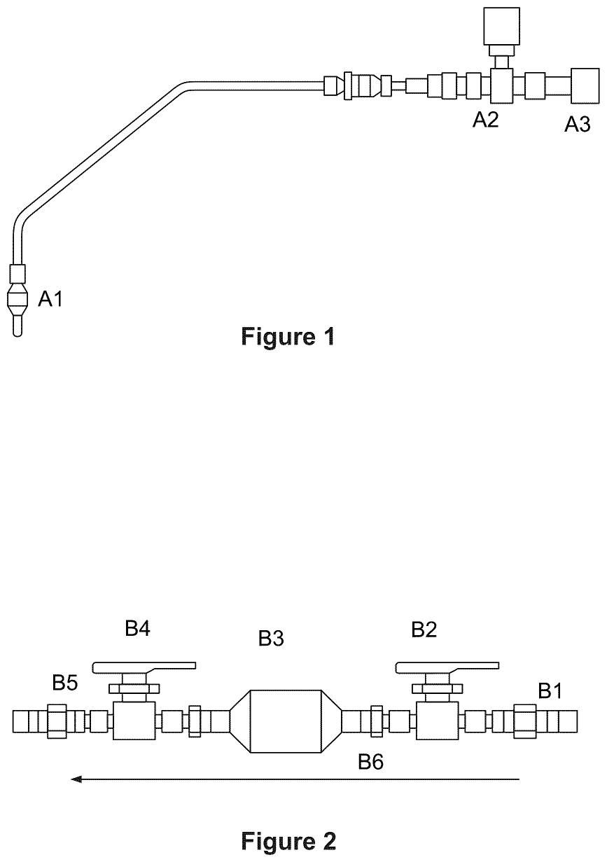

The first module of the injector system according to the present invention is the coupling module A for coupling the injector system to the unit to be inspected, shown in FIG. 1. It has coupling A1, which can be made by a ¼″ stainless steel washer connection, NTP threaded connection, or any other connection that is considered suitable for coupling to the unit to be inspected. Coupling A1 communicates with a flexible stainless steel high-pressure hose to a valve A2, for example, a needle valve, for controlling the flow of the radiotracer. A ¼″ NPT threaded connector interfaces between coupling A1 and valve A2. On the other side of valve A2 there is a quick-coupling male connection A3 for interfacing with module A2.

The second module of the injection system according to the present invention is module B containing the bottle for storing/transporting the radiotracer element, shown in FIG. 2. Module B has a quick-release female connection B1 suitable for coupling with the male connection C1 of the third module C, as will be seen below. It also has another quick-coupling female connection B5 suitable for connection with the male connection A3 of the first module A. Module B also has two single-way valves B2 and B4 to allow flow to pass in only one direction, in this case, in the direction from connection B1 to connection B5 indicated by arrow B6. Valves B2 and B4 can be implemented, for example, by ball valves. Valves B2 and B4 surround bottle B3 containing the radiotracer element. Bottle B3 is preferably a stainless steel cylinder with two inlets, internally coated with polytetrafluoroethylene (PTFE), and is connected to each of valves B2 and B4 in a separable manner, for example, via ¼″ NPT female threads.

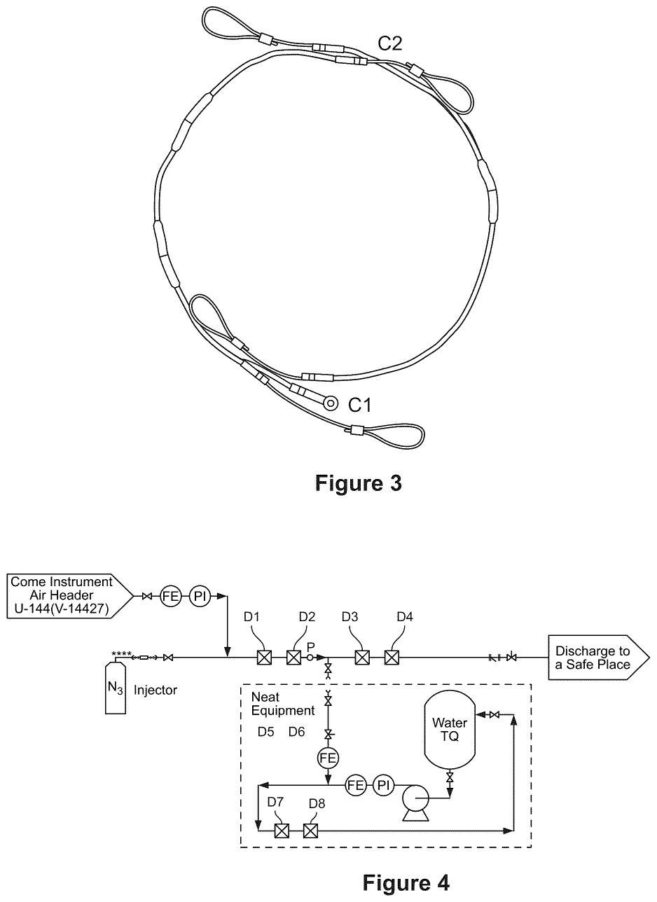

The third module of the injector system according to the present invention is the coupling module C for coupling a carrier gas cylinder (not shown), for example, a dry nitrogen cylinder, to inject the radiotracer element into the unit to be inspected, seen in FIG. 3. It has a quick-coupling male connection C1 for interfacing with the female connection B2 of the second module and connection C2 compatible with the connection of the carrier gas cylinder, and can be made with a ¼″ stainless steel washer or NTP scratch-resistant connection, for example.

The modular configuration of the injection system of the present invention allows the modules to be selectively connected and disconnected as required or necessary. For example, if bottle B3 needs to be replaced, simply close valves B2 and B4, placing them in a position that prevents flow for safety reasons, and disconnect connections B1 and B5. A new module B is then brought to the test point and connects to the original modules A and C to continue the test. Advantageously, this speeds up the continuity of testing since there is no need to disconnect the entire device.

Another possible scenario is to disconnect only connection B5 and take modules B and C to a new test point, where they will be connected to a new module A. This procedure is particularly advantageous as it allows testing of several points of the unit in a much shorter space of time than by conventional means.

In order to validate the inspection system above described, tests were performed in a controlled leak simulation plant consisting of a gaseous flow line (CO2) operating at high pressure (100 Bar) where a branch was installed that simulates a controlled leak to a water flow line operating at low pressure (12 Bar). The injector system was connected directly to the high pressure line, before the leak point where the branch is located for the controlled leak simulation. FIG. 4 shows the position of the injection system according to the present invention and the positions of the detectors in the leak simulation line. Eight scintillator detectors were installed, namely: D1 and D2 positioned on the high pressure line before the leak point P; D3 and D4 positioned on the same line, but after the leak point P; D5 and D6 at the interface between the high and low pressure lines and D7 and D8 positioned on the low pressure line.

### Injection 1: Leakage Line With Flow Rate Equal to 1.0% of the High Pressure Line Flow Rate

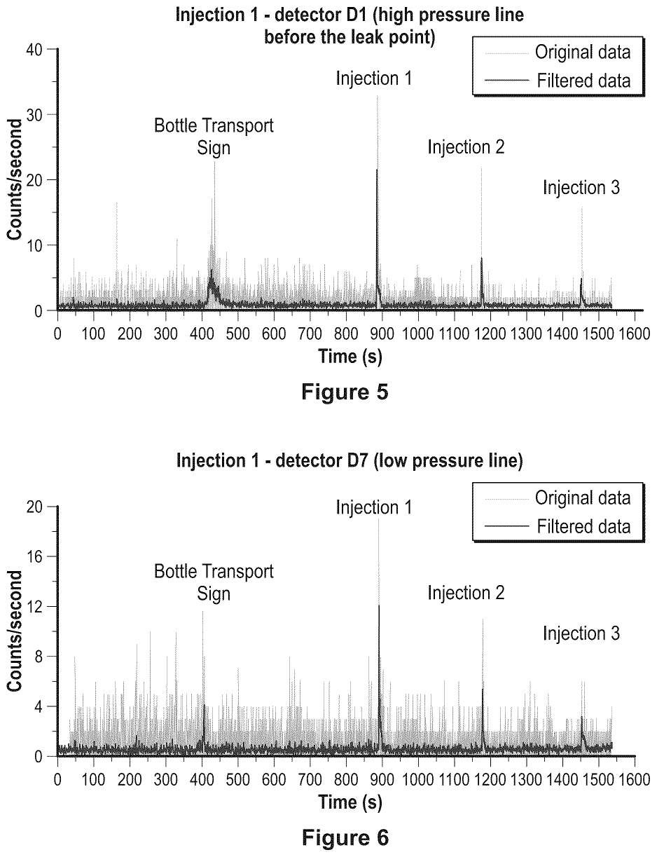

Three injections were performed in pulse form using bottle 1: the first, a 5.0 s pulse with the injector control valve 20% open recorded at around 900 s; the second with the control valve 50% open recorded at around 1200 s and the last the injection open until the bottle was empty recorded at around 1500 seconds. The objective of these three injections was to test the ability of the injector system to be used in the form of a rapid pulse injection (injection 1), and the last two in the form of a long pulse (injections 2 and 3) with the aim of evaluating the sensitivity of leak detection in relation to the format of the radiotracer injection. These three pulses are shown in FIG. 5 for detector D1: there is an initial peak around 400 s that corresponds to the movement of the bottle from the storage area to the installation point on the injector and does not correspond to the radiotracer signal in the lines. In FIG. 5, the gray curve represents the original data as stored in the multiple acquisition module and the red curve represents the result of the digital filter to eliminate the contribution of electronic noise and in FIG. 6 for the detector D7.

### Injection 2—Flow Rate Fraction in the Leakage Line Equal to 1% of the High Pressure Line Flow Rate

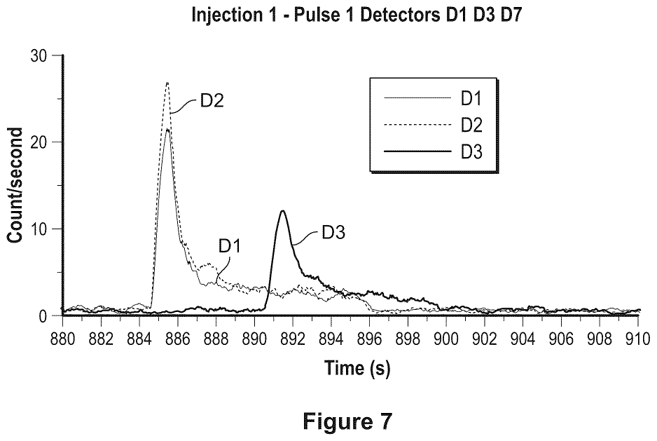

A second injection (wide pulse simulation) was performed. The injection was performed and immediately afterwards the detectors recorded the radioactive cloud as shown in FIG. 7 for the first set of detectors—D1, D3, D7. The data are count rate and have been filtered to eliminate the contribution of electronic noise using a Savitizky-Golay type digital filter.

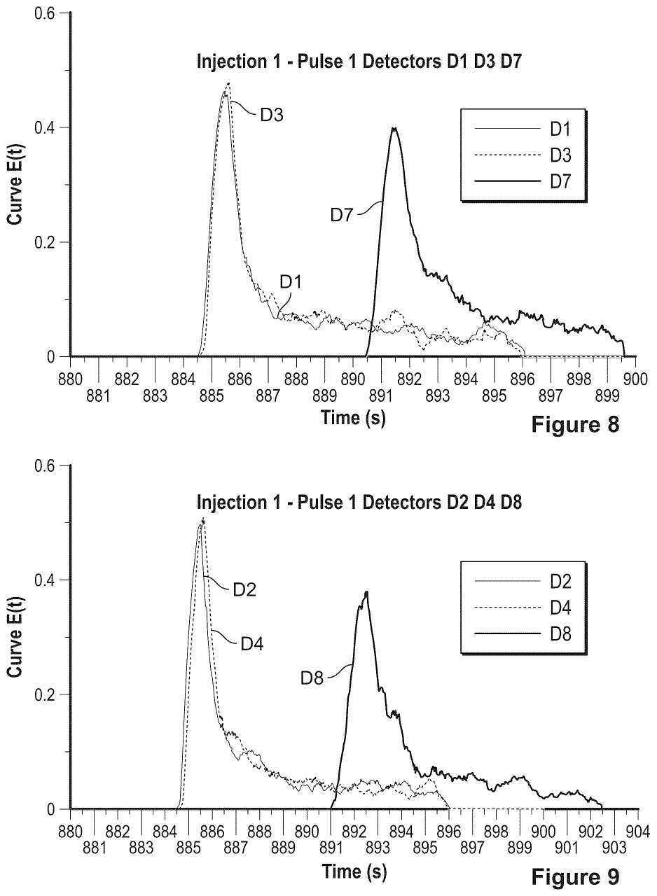

FIG. 8 shows the RTD curve record for the first set of detectors—D1, D3, D7—and FIG. 9 for detectors D2, D4 and D8, all using signal processing techniques that allow selecting only data relating to counts that come from radiotracer cloud signals, disregarding (replacing with null value) all data relating to electronic noise interference. Such techniques are known in the art, so they will not be detailed herein.

The Figures show that the injection system of the present invention made it possible to perform the wide pulse technique efficiently, since the length of the pulse recorded in detectors D1 and D2, positioned before the leakage point P and immediately after the injection system, was approximately 12.0 s. This allows a greater quantity of radiotracer to flow through the simulated leakage line and be transferred to the low pressure line, resulting in a very well-defined and easily detectable pulse.

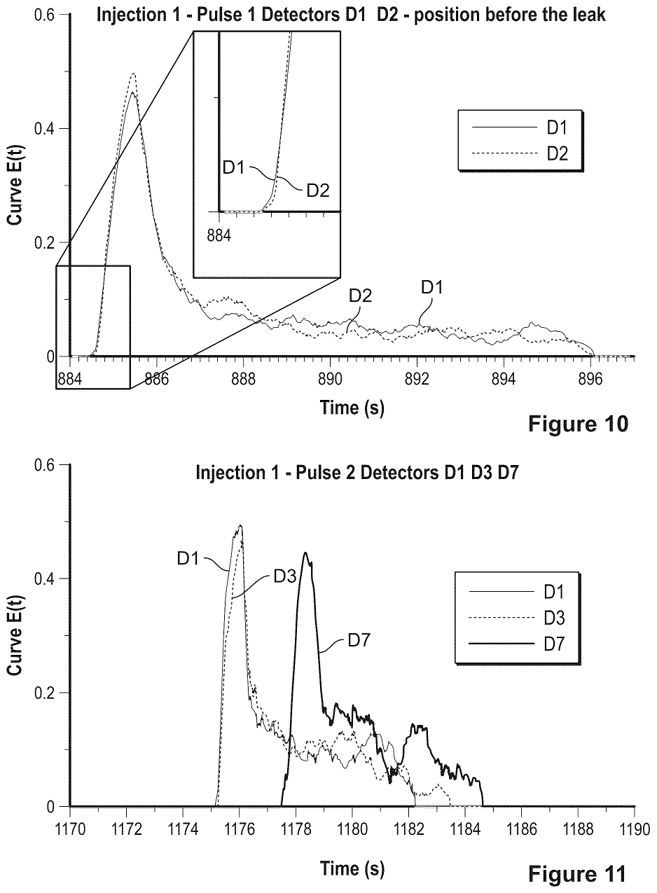

It is important to note that the height ratio between the high pressure and low pressure phase pulses needs to be corrected considering the flow velocity so that the areas can be compared. To do this, it is essential to measure the flow speed, which is not easy because the speed of the high pressure phase is very high. All data were acquired considering an interval between successive counts equal to 0.05 s (sampling frequency of 20 Hz) and the results show that, to correctly measure the flow velocity, it will be necessary to use a smaller value. FIG. 10 shows in detail the small time difference between D1 and D2.

The value of the time transient between D1 and D2 using the “cross-correlation” technique was calculated as equal to 0.0228 s with an uncertainty of the order of 50%. To improve these results, it would be advisable to proceed with data acquisition with a time interval five times smaller, that is, approximately equal to 0.01 s.

On the other hand, this time scale poses two problems. First, the data file size will grow in equal proportion and second, electronic noise interference will be more intense. There is currently research into new types of digital filters aimed at improving the process of removing electronic noise interference to enable the acquisition of all data with a sampling frequency of 100 Hz.

### Injection 1—Pulse 2

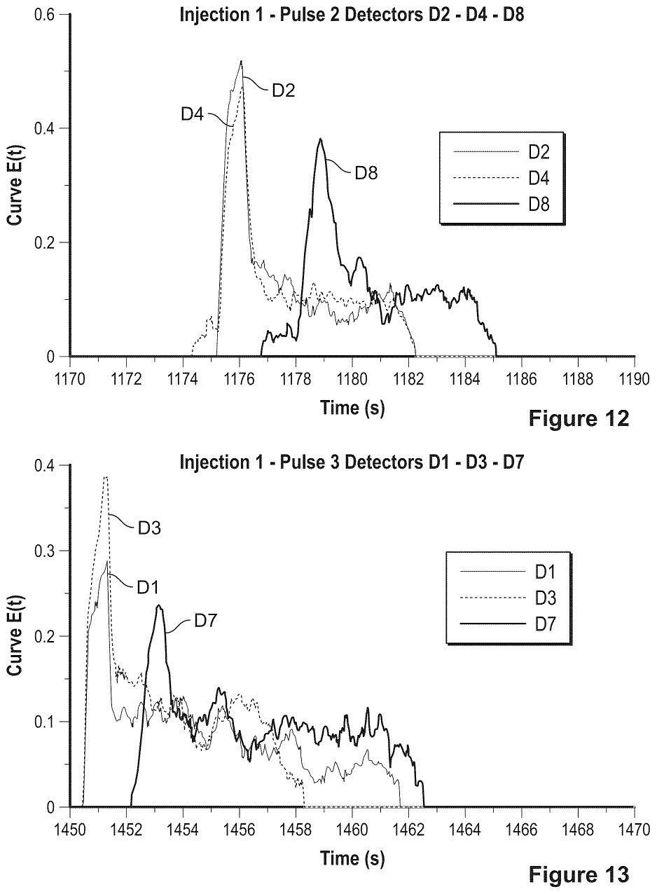

FIG. 11 and FIG. 12 show the results of the Residence Time Distribution (RTD) curves for detectors D1, D3, and D7 and D2, D4, and D8, respectively. In the residence time distribution curves, E(t), the effect of the intrinsic efficiency of each detector is corrected and the small difference between two nearby records (for example, D1 and D2 or D3 and D4) is a result of the flow profile inside the duct since, due to the high velocity, the radiotracer flow at the measurement positions is still in a non-stationary regime. FIG. 11 and FIG. 12 show the E(t) curve for pulse 2 and exhibit the same behavior as the previous curves.

This result shows that even with a smaller amount of radiotracer (pulse 2) the controlled leak considering the fraction equal to the controlled flow rate of 1.0% of the high pressure line flow rate value, the radiotracer signal was detected in the low pressure line, thus proving the sensitivity of the method for identifying leaks in a real heat exchanger.

### Injection 1—Pulse 3: Emptying of the Bottle Activity

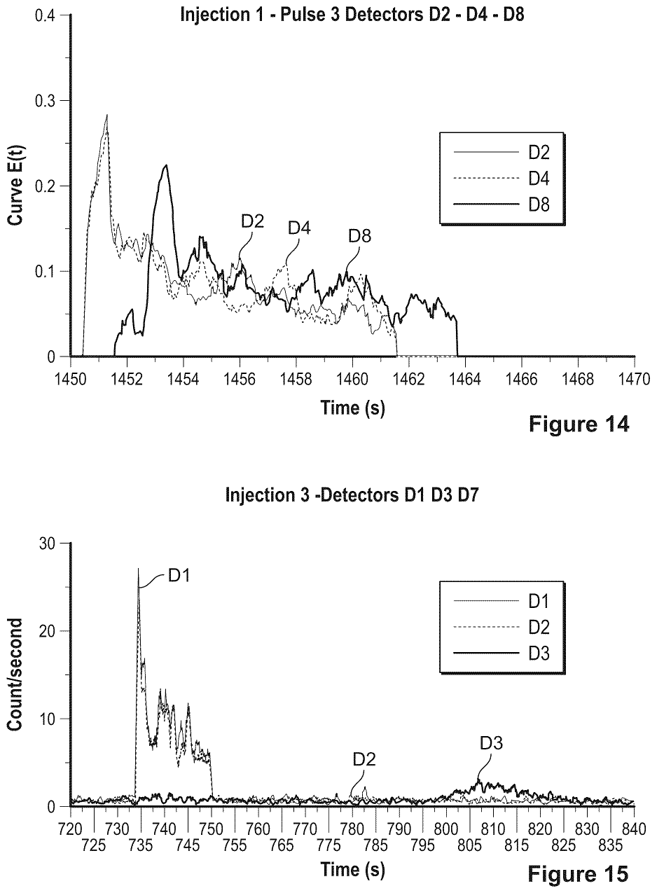

This injection contained the smallest amount of radiotracer. Nevertheless, the signal was recorded in all detectors and the results of the E(t) curves for the first and second set of detectors are shown in FIG. 13 and FIG. 14, respectively.

### Injection 3—Flow Rate Fraction in the Leakage Line Equal to 0.2% of the High Pressure Line Flow Rate

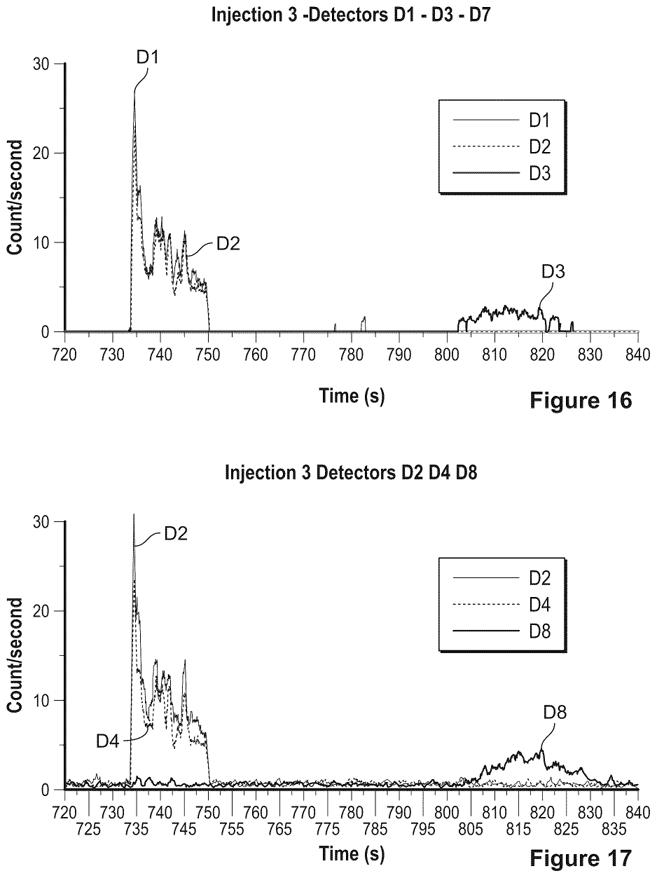

In this test, aiming to evaluate the sensitivity of the technique in identifying low-intensity leaks, a flow rate equivalent to 0.1% of the high-pressure line flow rate was adjusted in the leak simulation line and a new bottle was installed in the injection system. For this test, the control valve (A2) of the injection system was set to 50% opening and a single pulse of 12 s duration was executed. The results of the radiotracer cloud recording for detectors D1, D3 and D7 are shown in FIG. 15 for the pure data, that is, only with the Savistky-Golay filter, and in FIG. 16 the same signal treated with the methodology used to identify and differentiate the presence of a radiotracer signal from the background radiation. These two methodologies are necessary to certify that the signal really comes from the simulated leak, since the amount of radiotracer that passed through the leak point is very small.

It is noted that in the case of the curve for detector D1, spurious peaks appear around t=780 s, but the intensity is very small, corresponding to only 0.2% of the total value of the integrated area and is probably noise. For the detector D7, the digital filter treatment was very selective and allowed the clear identification of the radiotracer signal that was transferred to the low pressure line and did not identify any signal or noise, but identified the signal of the noise spurious peaks between t=795 and t=902 s. This result demonstrates that the detection methodology, despite identifying the real tracer signal in the low pressure line, needs to be improved so as not to identify noise in the high pressure line as a signal.

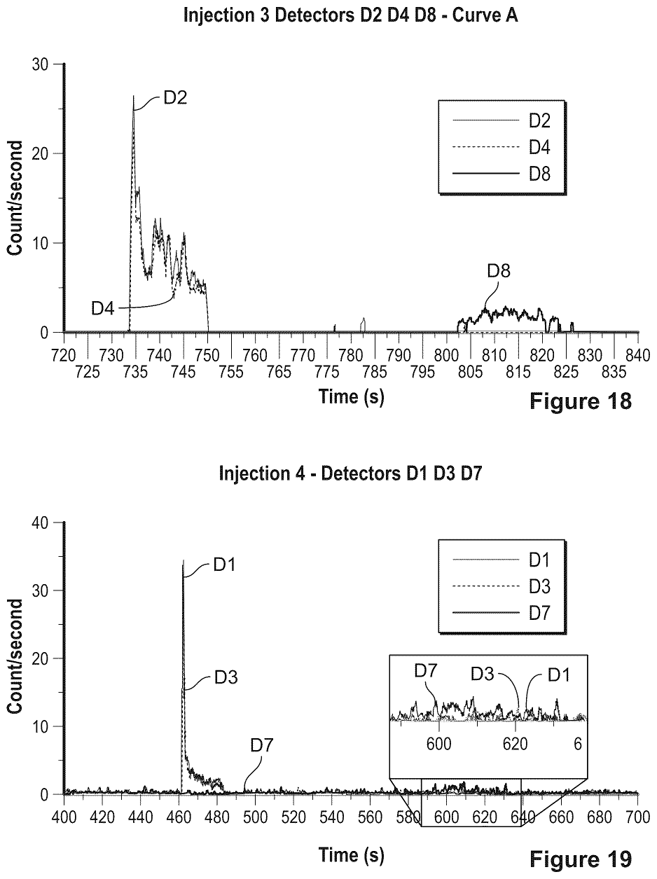

FIG. 17 and FIG. 18 show the same results for the second set of detectors D2, D4 and D8.

### Injection 4—Flow Rate Fraction in the Leakage Line Equal to 0.01% of the High Pressure Line Flow Rate

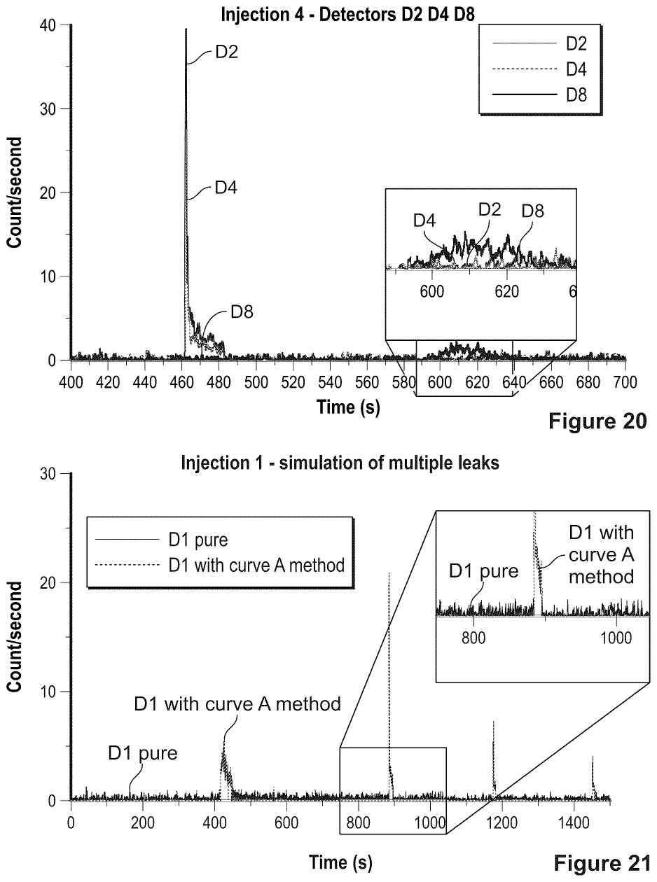

In this test, a third bottle with radiotracer was installed in the injection system and the flow rate of the leakage simulation line adjusted to a value equal to 0.01% of the high pressure line flow rate. In this test, the leakage line had a very low flow rate, so the fluid flow speed inside it was very slow. This caused the radiotracer to suffer greater action from the chemical diffusion process in the compressed air and, therefore, the peak recorded in the low pressure line is wider, as can be seen in FIG. 19 and FIG. 20.

### Simulation of Multiple Leaks in a Heat Exchanger

The use of the digital filter methodology allows identifying situations with multiple leak points in a heat exchanger. In the real case of radiotracer injection into a heat exchanger with more than one leak point, the signal recorded by scintillator detectors positioned in the low pressure phase may present a sequence of pulses which intensity will be directly proportional to the leak intensity. Furthermore, the distance between these pulses recorded in the detector positioned in the low pressure line is directly linked to the location where the leak occurs, for example: a first radiotracer packet corresponds to a leak located in a portion closer to the exit point of the low pressure phase, while packets with a higher residence time correspond to leak positions further away from the exit point of the low pressure phase. This feature allows the heat exchanger operator to be provided with an assessment of the leak point location.

To simulate a situation like this, we use data files containing four pulses: a pulse referring to the movement of the bottle before installation at the injection point and those corresponding to the three injections carried out.

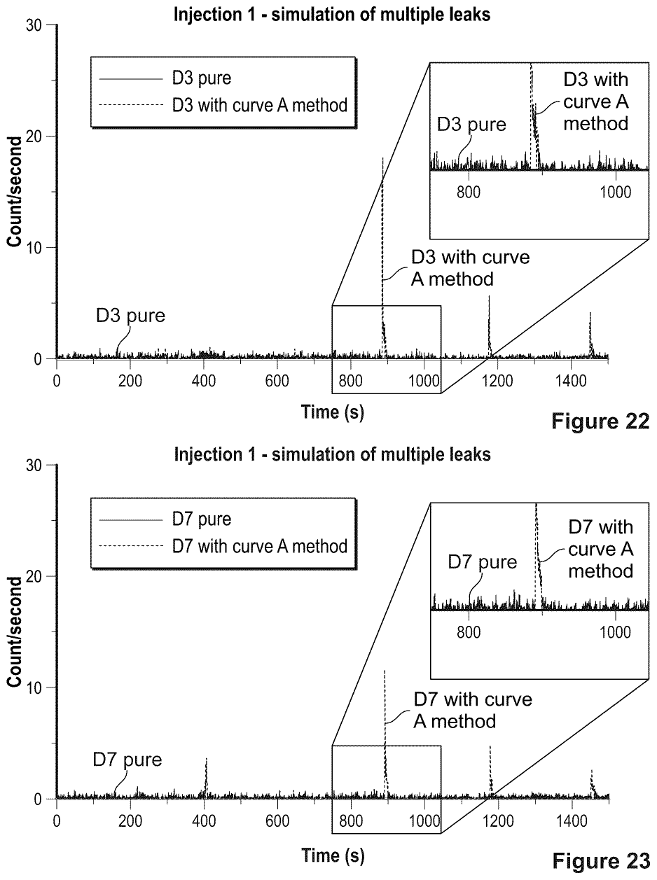

FIG. 21 shows the curves for the filtered-only data and the processed data for D1. FIG. 22 shows the equivalent curves for D3, and FIG. 23 shows the equivalent curves for D7.

The invention described herein has at least the following advantages:
Detection and location of leak points in printed circuit heat exchangers;
Provision of essential information for planning scheduled shutdowns of offshore units;
Reduction in spent time for inspecting printed circuit heat exchangers;
Reduction of impacts on operations and operational discontinuity resulting in savings due to low downtime of equipment and machines. The present invention is considered minimally invasive because the only invasive operation is the injection of the radiotracer, which is carried out at an existing point and does not require any changes to be made to the production line;
Quick identification of the region where the leak point is located, allowing repairs to be carried out with less shutdown for equipment maintenance;
Savings from increased industrial safety and reduced scrap.

Although the aspects of the present disclosure may be susceptible to various modifications and alternative forms, specific embodiments have been shown by way of example in the drawings and have been described in detail herein. But it should be understood that the invention is not intended to be limited to the particular forms disclosed. Instead, the invention must cover all modifications, equivalents and alternatives that fall within the scope of the invention as defined by the following appended claims.

What is claimed is:

1. A system for inspecting leaks using radiotracers comprising:
a coupling module (A) for coupling the injector system to a unit to be inspected, comprising a coupling (A1), a valve (A2) and a male connection (A3);
a module (B) containing a bottle storing a radiotracer element, comprising a quick-coupling female connection (B1), a female connection (B5), two one-way valves (B2, B4) and a bottle (B3) for storing the radiotracer element; and
a coupling module (C), comprising a male quick-coupling connection (C1) and a connection (C2) compatible with the connection of a carrier gas cylinder.

2. The system, according to claim 1, wherein the coupling (A1) is made by washer connection or threaded connection.

3. The system, according to claim 1, wherein the coupling (A1) communicates with a flexible stainless steel hose with the valve A2.

4. The system, according to claim 1, wherein it employs a needle valve for the valve (A2).
